(19) United States
(12) Patent Application Publication
(10) Pub. No.: US 2018/0048051 A1
(43) Pub. Date: Feb. 15, 2018

(54) Multi-Band Antenna and Terminal Device

(71) Applicant: Huawei Technologies Co., Ltd., Shenzhen (CN)

(72) Inventors: Chih-Hua Chang, Taipei (TW); Jianming Li, Shanghai (CN); Yuzhan Yang, Taipei (TW); Hanyang Wang, Reading (UK)

(21) Appl. No.: 15/550,717

(22) PCT Filed: Feb. 11, 2015
(86) PCT No.: PCT/CN2015/072782

§ 371 Date: Aug. 11, 2017

(51) Int. Cl. H01Q 1/24; H01Q 9/04; H01Q 5/335

(52) U.S. Cl. CPC H01Q 1/243; H01Q 5/335; H01Q 9/0421; H01Q 1/247; H01Q 1/48

(57) ABSTRACT

A multi-band antenna and a terminal device, where the multi-band antenna includes a feeding part connected to a capacitor component to form a feeding circuit, and a feeding matching circuit is electrically connected between a feeding radio frequency circuit and the feeding circuit, a radiation part is electrically connected both to the feeding circuit and a grounding part, the grounding part is electrically connected to a ground plane, a first resonant circuit is formed from the feeding circuit to an end that is of the radiation part and that is away from the grounding part, and the first resonant circuit generates a first resonance frequency and a second resonance frequency.

### CROSS-REFERENCE TO RELATED APPLICATIONS

This application is a U.S. National Stage of International Patent Application No. PCT/CN2015/072782 filed on Feb. 11, 2015, which is hereby incorporated by reference in its entirety.

### TECHNICAL FIELD

Embodiments of the present disclosure relate to antenna technologies, and in particular, to a multi-band antenna and a terminal device.

### BACKGROUND

With development of wireless communications technologies, portable terminal devices such as a smartphone or a tablet computer are increasingly used. To attract consumers to make a purchase, a manufacturer of portable terminal devices needs to continuously improve the portable terminal devices.

An appearance is a first impression that a consumer has on a portable terminal device. Therefore, to attract a consumer to purchase a portable terminal device, in addition to continuous improvement of software and hardware performance of the portable terminal device, appearance factors such as an appearance of the portable terminal device and holding feeling have become increasingly important. Currently, a portable terminal device such as a high-end smartphone or tablet computer is developing towards a trend of lightness and thinness. In addition, to increase product texture, a metallic material is used as a main element in design of an appearance part (for example, a rear housing of a mobile phone) of the portable terminal device.

However, currently, all portable terminal devices support wireless communication functions of multiple standards, for example, mobile communication of various standards such as WI-FI, Global Positioning System (GPS), BLUETOOTH, Code Division Multiple Access (CDMA), Global System for Mobiles (GSM), and Long-Term Evolution (LTE). A multi-band antenna needs to be configured for the portable terminal device, and to improve an appearance of the portable terminal device, built-in design needs to be used for the antenna. A length of a built-in antenna is generally a quarter of a wavelength corresponding to a resonance frequency. How to reduce an antenna size to better apply an antenna to a terminal device is a problem to be urgently resolved at present.

### SUMMARY

Embodiments of the present disclosure provide a multi-band antenna and a terminal device, which can reduce an antenna size.

A first aspect provides a multi-band antenna, including a feeding matching circuit, a feeding part, a capacitor component, a radiation part, and a grounding part, where the feeding part is connected to the capacitor component to form a feeding circuit, and the feeding matching circuit is electrically connected between a feeding radio frequency circuit and the feeding circuit, and the radiation part is electrically connected both to the feeding circuit and the grounding part, the grounding part is electrically connected to a ground plane, a first resonant circuit is formed from the feeding circuit to an end that is of the radiation part and that is away from the grounding part, the first resonant circuit generates a first resonance frequency and a second resonance frequency, the first resonance frequency is a GPS frequency, the second resonance frequency is a multiplied frequency of the first resonance frequency, a length of the first resonant circuit ranges from 0.12 times to 0.18 times as great as a wavelength corresponding to the first resonance frequency, and a width of the grounding part ranges from 0.5 millimeter (mm) to 2.5 mm.

With reference to the first aspect, in a first possible implementation manner of the first aspect, a groove is disposed on the radiation part, the groove extends to the grounding part from the end that is of the radiation part and that is away from the grounding part, the groove is configured to form a second resonant circuit on the radiation part, the second resonant circuit generates a third resonance frequency, and the third resonance frequency is different from the first resonance frequency and the second resonance frequency.

With reference to the first aspect or the first possible implementation manner of the first aspect, in a second possible implementation manner of the first aspect, a capacitance value of the capacitor component is inversely proportional to the first resonance frequency.

With reference to any one of the first aspect to the second possible implementation manner of the first aspect, in a third possible implementation manner of the first aspect, the width of the grounding part is inversely proportional to the second resonance frequency.

With reference to any one of the first aspect to the third possible implementation manner of the first aspect, in a fourth possible implementation manner of the first aspect, the ground plane is a copper layer of a circuit board.

A second aspect provides a terminal device, including a housing, a baseband processing circuit, a frequency mixing circuit, a feeding radio frequency circuit, and a multi-band antenna, where the baseband processing circuit, the frequency mixing circuit, the feeding radio frequency circuit, and the multi-band antenna are located inside the housing, the baseband processing circuit and the frequency mixing circuit are connected to the feeding radio frequency circuit, and the multi-band antenna includes a feeding matching circuit, a feeding part, a capacitor component, a radiation part, and a grounding part, where the feeding part is connected to the capacitor component to form a feeding circuit, and the feeding matching circuit is electrically connected between the feeding radio frequency circuit and the feeding circuit, and the radiation part is electrically connected both to the feeding circuit and the grounding part, the grounding part is electrically connected to a ground plane, a first resonant circuit is formed from the feeding circuit to an end that is of the radiation part and that is away from the grounding part, the first resonant circuit generates a first resonance frequency and a second resonance frequency, the first resonance frequency is a GPS frequency, the second resonance frequency is a multiplied frequency of the first resonance frequency, a length of the first resonant circuit ranges from 0.12 times to 0.18 times as great as a wavelength corresponding to the first resonance frequency, and a width of the grounding part ranges from 0.5 mm to 2.5 mm.

With reference to the second aspect, in a first possible implementation manner of the second aspect, a groove is disposed on the radiation part, the groove extends to the grounding part from the end that is of the radiation part and that is away from the grounding part, the groove is configured to form a second resonant circuit on the radiation part, the second resonant circuit generates a third resonance frequency, and the third resonance frequency is different from the first resonance frequency and the second resonance frequency.

With reference to the second aspect or the first possible implementation manner of the second aspect, in a second possible implementation manner of the second aspect, a capacitance value of the capacitor component is inversely proportional to the first resonance frequency.

With reference to any one of the second aspect to the second possible implementation manner of the second aspect, in a third possible implementation manner of the second aspect, the width of the grounding part is inversely proportional to the second resonance frequency.

With reference to any one of the second aspect to the third possible implementation manner of the second aspect, in a fourth possible implementation manner of the second aspect, the ground plane is a copper layer of a circuit board in the terminal device.

A third aspect provides a multi-band antenna, including a feeding matching circuit, a feeding part, a capacitor component, a radiation part, and a grounding part, where the feeding part is connected to the capacitor component to form a feeding circuit, and the feeding matching circuit is electrically connected between a feeding radio frequency circuit and the feeding circuit, and the radiation part is electrically connected both to the feeding circuit and the grounding part, the grounding part is electrically connected to a ground plane, a first resonant circuit is formed from the feeding circuit to an end that is of the radiation part and that is away from the grounding part, the first resonant circuit generates a first resonance frequency and a second resonance frequency, and the second resonance frequency is a multiplied frequency of the first resonance frequency.

With reference to the third aspect, in a first possible implementation manner of the third aspect, a groove is disposed on the radiation part, the groove extends to the grounding part from the end that is of the radiation part and that is away from the grounding part, the groove is configured to form a second resonant circuit on the radiation part, the second resonant circuit generates a third resonance frequency, and the third resonance frequency is different from the first resonance frequency and the second resonance frequency.

With reference to the third aspect or the first possible implementation manner of the third aspect, in a second possible implementation manner of the third aspect, a length of the groove is inversely proportional to the third resonance frequency.

With reference to any one of the third aspect to the second possible implementation manner of the third aspect, in a third possible implementation manner of the third aspect, a width of the grounding part is inversely proportional to the second resonance frequency.

With reference to any one of the third aspect to the third possible implementation manner of the third aspect, in a fourth possible implementation manner of the third aspect, the ground plane is a copper layer of a circuit board.

A fourth aspect provides a terminal device, including a housing, a baseband processing circuit, a frequency mixing circuit, a feeding radio frequency circuit, and a multi-band antenna, where the baseband processing circuit, the frequency mixing circuit, the feeding radio frequency circuit, and the multi-band antenna are located inside the housing, the baseband processing circuit and the frequency mixing circuit are connected to the feeding radio frequency circuit, and the multi-band antenna includes a feeding matching circuit, a feeding part, a capacitor component, a radiation part, and a grounding part, where the feeding part is connected to the capacitor component to form a feeding circuit, and the feeding matching circuit is electrically connected between the feeding radio frequency circuit and the feeding circuit, and the radiation part is electrically connected both to the feeding circuit and the grounding part, the grounding part is electrically connected to a ground plane, a first resonant circuit is formed from the feeding circuit to an end that is of the radiation part and that is away from the grounding part, the first resonant circuit generates a first resonance frequency and a second resonance frequency, and the second resonance frequency is a multiplied frequency of the first resonance frequency.

With reference to the fourth aspect, in a first possible implementation manner of the fourth aspect, a groove is disposed on the radiation part, the groove extends to the grounding part from the end that is of the radiation part and that is away from the grounding part, the groove is configured to form a second resonant circuit on the radiation part, the second resonant circuit generates a third resonance frequency, and the third resonance frequency is different from the first resonance frequency and the second resonance frequency.

With reference to the fourth aspect, in a first possible implementation manner of the fourth aspect, a length of the groove is inversely proportional to the third resonance frequency.

With reference to any one of the fourth aspect to the second possible implementation manner of the fourth aspect, in a third possible implementation manner of the fourth aspect, a width of the grounding part is inversely proportional to the second resonance frequency.

With reference to any one of the fourth aspect to the third possible implementation manner of the fourth aspect, in a fourth possible implementation manner of the fourth aspect, the ground plane is a copper layer of a circuit board in the terminal device.

According to the multi-band antenna and the terminal device provided in the embodiments of the present disclosure, disposing a capacitor component between a feeding part and a radiation part is equivalent to disposing a series resistor for the radiation part of the antenna, and a path between a grounding part and the feeding part that are of the antenna is equivalent to a parallel inductor. The feeding part, the series resistor, and the parallel inductor form a multi-band antenna that complies with a composite right/left handed (CRLH) principle, which can reduce an antenna size.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show some embodiments of the present disclosure, and persons of ordinary skill in the art may still derive other drawings from these accompanying drawings without creative efforts.

FIG. 1 is a multi-band antenna;

FIG. 2 is a schematic structural diagram of Embodiment 1 of a multi-band antenna according to an embodiment;

FIG. 3 is a schematic diagram of spectrums of a first resonance frequency corresponding to different capacitance values of a capacitor component;

FIG. 4 is a schematic diagram of spectrums of a first resonance frequency corresponding to different widths of a grounding part;

FIG. 5 is a schematic structural diagram of Embodiment 2 of a multi-band antenna according to an embodiment of the present disclosure;

FIG. 6 is a schematic structural diagram of Embodiment 3 of a multi-band antenna according to an embodiment of the present disclosure;

FIG. 7 is a schematic structural diagram of Embodiment 4 of a multi-band antenna according to an embodiment of the present disclosure;

FIG. 8 is a schematic structural diagram of Embodiment 5 of a multi-band antenna according to an embodiment of the present disclosure;

FIG. 9 is a schematic structural diagram of Embodiment 6 of a multi-band antenna according to an embodiment of the present disclosure;

FIG. 10 is a diagram of antenna radiation efficiency of the multi-band antenna in the embodiment shown in FIG. 9;

FIG. 11 is a schematic structural diagram of Embodiment 7 of a multi-band antenna according to an embodiment of the present disclosure;

FIG. 12A, FIG. 12B, and FIG. 12C are schematic diagrams of surface current distribution and electric field distribution of the multi-band antenna shown in FIG. 11;

FIG. 13 is a schematic structural diagram of Embodiment 1 of a terminal device according to an embodiment of the present disclosure;

FIG. 14 is a schematic structural diagram of Embodiment 8 of a multi-band antenna according to an embodiment;

FIG. 15 is a schematic structural diagram of Embodiment 9 of a multi-band antenna according to an embodiment of the present disclosure; and

FIG. 16 is a schematic structural diagram of Embodiment 2 of a terminal device according to an embodiment of the present disclosure.

### DESCRIPTION OF EMBODIMENTS

To make the objectives, technical solutions, and advantages of the embodiments of the present disclosure clearer, the following clearly and completely describes the technical solutions in the embodiments of the present disclosure with reference to the accompanying drawings in the embodiments of the present disclosure. The described embodiments are some but not all of the embodiments of the present disclosure. All other embodiments obtained by persons of ordinary skill in the art based on the embodiments of the present disclosure without creative efforts shall fall within the protection scope of the present disclosure.

Because a portable terminal device integrates more functions, a multi-band antenna that can provide multiple resonance frequencies needs to be configured for the portable terminal device. Currently, antennas in portable terminal devices are designed mainly based on an architecture of an inverted F antenna (IFA) or an architecture of a planar inverted F antenna (PIFA). The multi-band antenna is designed mainly using an architecture of multiple resonant circuits plus a parasitic circuit.

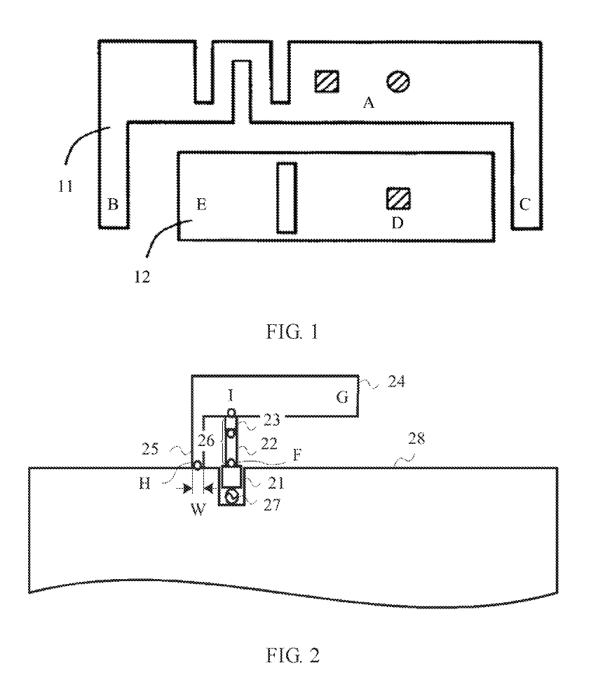

FIG. 1 is a multi-band antenna. A technical implementation manner of the multi-band antenna is that different resonant modes may be simultaneously generated by means of excitation using the multiple resonant circuits of different lengths in the antenna. In FIG. 1, on an antenna 11, a point A is a feed point, a path AB and a path AC are two different resonant circuits, and a section of a grounding parasitic circuit 12 is added near the feed point or a grounding point of the antenna. In the parasitic circuit 12, a point D is a grounding point, and an extra resonant mode may be generated on a path DE. By adjusting sizes of the antenna 11 and the parasitic circuit 12, the antenna 11 shown in FIG. 1 may generate three resonant modes of different frequencies. In addition, according to a principle of the antenna 11 shown in FIG. 1, an antenna that may generate more than three resonant modes of different frequencies can be designed. The antenna 11 shown in FIG. 1 is still based on the IFA architecture, and a size of a resonant circuit of the antenna 11 that generates a fundamental frequency is generally a quarter of a wavelength. If the antenna 11 includes multiple resonant circuits and parasitic circuits, an overall size of the antenna 11 is increased based on a quarter of a wavelength of the fundamental frequency. However, for a design trend of an increasingly miniaturized portable terminal, the antenna 11 of such a size is still relatively large. In addition, when the antenna based on the IFA or PIFA architecture works at the fundamental frequency, surface currents mainly concentrate on a radiation part of the antenna (that is, near a point B in FIG. 1). If there is a ground terminal near the antenna, such design causes significant reduction of bandwidth and radiation efficiency of the antenna. Therefore, the antenna 11 that is based on the IFA or PIFA architecture and that is shown in FIG. 1 is hardly applied to a portable device with an all-metal back cover.

To resolve problems that the size of the multi-band antenna is relatively large in the foregoing portable terminal device, and that a solution in FIG. 1 is hardly applied to a portable device with an all-metal back cover, the embodiments of the present disclosure provide a multi-band antenna that is based on CRLH design and a terminal device that uses the CRLH-based antenna.

FIG. 2 is a schematic structural diagram of Embodiment 1 of a multi-band antenna according to an embodiment. As shown in FIG. 2, the multi-band antenna in this embodiment includes a feeding matching circuit 21, a feeding part 22, a capacitor component 23, a radiation part 24, and a grounding part 25.

The feeding part 22 is connected to the capacitor component 23 to form a feeding circuit 26, the feeding matching circuit 21 is electrically connected between a feeding radio frequency circuit 27 and the feeding part 22, and the capacitor component 23 is connected to the radiation part 24. The feeding matching circuit 21 is configured to match a radio frequency signal in the feeding radio frequency circuit 27, and transmit the signal to the feeding circuit 26. The feeding part 22 is configured to feed a radio frequency signal generated by the feeding radio frequency circuit 27 into the radiation part 24, or feed a radio frequency signal generated by the radiation part 24 into the feeding radio frequency circuit 27. The radiation part 24 is electrically connected both to the capacitor component 23 and the grounding part 25, the grounding part 25 is electrically connected to a ground plane 28, a first resonant circuit (that is, a path from a point F to a point G in FIG. 2) is formed from the feeding circuit 26 to an end that is of the radiation part 24 and that is away from the grounding part 25, and the first resonant circuit generates a first resonance frequency and a second resonance frequency. Generally, the grounding part 25 and the radiation part 24 may be an integrated metal plate, that is, a part of the radiation part 24 extending to the ground plane 28 is the grounding part 25. A width of the grounding part 25 may be W.

The feeding part 22, the radiation part 24, and the grounding part 25 form a basic antenna structure. In addition, impedance does not match between the feeding radio frequency circuit 27 and the feeding part 22. Therefore, the feeding matching circuit 21 is further electrically connected between the feeding radio frequency circuit 27 and the feeding part 22. The feeding matching circuit 21 is configured to match a radio frequency signal in the feeding radio frequency circuit 27 and the feeding part 22, including matching a signal transmitted by the feeding radio frequency circuit 27 and transmitting the matched signal to the feeding circuit 26, and then radiating the matched signal using the radiation part 24, or matching a signal that is transmitted by the feeding circuit 26 and that is received by the radiation part 24, and then transmitting the matched signal to the feeding radio frequency circuit 27. The capacitor component 23 is further disposed between the feeding part 22 and the radiation part 24, where the capacitor component 23 and the feeding part 22 form the feeding circuit 26. The capacitor component 23 may be a lumped capacitor, or may be a distributed capacitor. If the capacitor component 23 is a lumped capacitor, the lumped capacitor device whose capacitance value is determined is connected (for example, in a welding manner) between the feeding part 22 and the radiation part 24. If the capacitor component 23 is a distributed capacitor, a specific gap may be reserved between the feeding part 22 and the radiation part 24. The gap presents a characteristic of the distributed capacitor, and the capacitance value of the distributed capacitor may be adjusted by adjusting a width of the gap between the feeding part 22 and the radiation part 24. For example, when the width of the gap between the feeding part 22 and the radiation part 24 is 0.3 mm, the capacitance value of the distributed capacitor may be equivalent to a 0.4 picofarads (pF) capacitance value of the lumped capacitor.

In the multi-band antenna provided in this embodiment, the first resonance frequency may be a GPS frequency. The GPS frequency is divided into three frequency bands L1, L2, and L3, whose frequencies are respectively 1.57542 gigahertz (GHz) for the L1 frequency band, 1.22760 GHz for the L2 frequency band, and 1.38105 GHz for the L3 frequency band. In this embodiment, the L1 frequency band of the GPS is used as an example, that is, the first resonance frequency is 1.57542 GHz. A length of the first resonant circuit (that is, the path from the point F to the point G) ranges from 0.12 times to 0.18 times as great as a wavelength corresponding to the first resonance frequency. If the first resonance frequency is 1.57542 GHz, the calculated length of the first resonant circuit may approximately range from 30.5 mm to 34.3 mm. The second resonance frequency is a multiplied frequency of the first resonance frequency. Further, the second resonance frequency may be 1.5 times of the first resonance frequency, the second resonance frequency may be 2.5 times of the first resonance frequency, or the second resonance frequency may be 3 times of the first resonance frequency. In this embodiment, the second resonance frequency may be 3.5 times of the first resonance frequency. For example, the first resonance frequency is 1.57542 GHz, and the second resonance frequency is approximately 5.5 GHz, which is a WI-FI frequency. The width W of the grounding part 25 may range from 0.5 mm to 2.5 mm, for example, the width W of the grounding part may be equal to 1 mm. Certainly, the width of the grounding part 25 may alternatively be 0.8 mm, 2 mm, or 2.2 mm.

The multi-band antenna provided in this embodiment is disposed in a terminal device that needs to work in multiple wireless frequency bands. The feeding radio frequency circuit 27 is disposed in the terminal device, where the feeding radio frequency circuit 27 is configured to process a radio frequency signal received using the multi-band antenna or transmit a generated radio frequency signal using the multi-band antenna. The ground plane 28 for grounding is further disposed in the terminal device. The ground plane 28 is generally a copper cover on a circuit board in the terminal device, for example, a copper layer of the circuit board.

In the multi-band antenna shown in FIG. 2, a part from a connection point H between the grounding part 25 and the ground plane 28 to a connection point I between the feeding circuit 26 and the radiation part 24 forms an inductor that is in parallel with the radiation part 24. The capacitor component 23 and the radiation part 24 are in a serial connection relationship, which is equivalent to a series resistor. According to the principle of the CRLH antenna, the parallel inductor and the series resistor form a core component that complies with a principle of a right/left handed transmission line, and the path from the point G that is of the radiation part 24 of the multi-band antenna and that is away from the grounding part 25 to the point F connected between the feeding part 22 and the feeding radio frequency circuit 27 forms the first resonant circuit. The first resonant circuit generates the first resonance frequency, where the first resonance frequency is a fundamental frequency of the multi-band antenna. In addition, according to the CRLH principle, the first resonant circuit further generates the second resonance frequency, where the second resonance frequency is a multiplied frequency of the first resonance frequency. The first resonance frequency complies with a left handed rule, and the length of the first resonant circuit ranges from 0.12 times to 0.18 times as great as a wavelength corresponding to the first resonance frequency. For example, the length of the first resonant circuit is 0.125 times as great as the wavelength corresponding to the first resonance frequency. The second resonance frequency complies with a right handed rule. Therefore, the multi-band antenna shown in FIG. 2 generates two resonance frequencies, and the first resonance frequency and the second frequency may be adjusted by adjusting sizes and parameters of various parts in the multi-band antenna. By adjusting a length of the path from the point G to the point F, the length of the first resonant circuit may be adjusted, that is, a magnitude of the first resonance frequency is adjusted, and a magnitude of the second resonance frequency also changes. By adjusting a capacitance value of the capacitor component 23, a resonance frequency may be adjusted for the first resonant circuit, where the capacitance value of the capacitor component 23 is inversely proportional to the first resonance frequency. By adjusting a width W of the grounding part 25, the second resonance frequency may also be adjusted, where the width W of the grounding part 25 is inversely proportional to the second resonance frequency. Increasing the width W of the grounding part 25 is equivalent to increasing an equivalent inductance value of the inductor that is in parallel with the first resonant circuit.

It can be learned from the principle of the CRLH antenna that, for the antenna based on the CRLH principle, a length of a resonant circuit that generates a fundamental frequency approximately ranges from 0.12 times to 0.18 times as great as a wavelength corresponding to the fundamental frequency. In contrast, for the antenna (for example, the antenna shown in FIG. 1) designed based on the IFA or PIFA principle, a length of a resonant circuit that generates a fundamental frequency is approximately 0.25 times as great as a wavelength corresponding to the fundamental frequency. Therefore, the wavelength corresponding to the fundamental frequency for the multi-band antenna provided in this embodiment may be 0.09 times shorter than that for the antenna based on the IFA or PIFA principle, which is quite important to a terminal device of increasingly miniaturized design. Because the fundamental frequency of the multi-band antenna in this embodiment is designed at a GPS frequency, in an L1 frequency band of GPS, a center frequency of the fundamental frequency of the multi-band antenna is 1575 megahertz (MHz), and a wavelength corresponding to 1575 MHz is approximately 190 mm. If the antenna designed based on the IFA or PIFA principle is used, a length of the antenna is approximately 47.6 mm. If the antenna provided in this embodiment is used, a length of the antenna ranges approximately from 30.5 mm to 34.3 mm. A length difference between the two antennas reaches 17.1 mm. Considering that an existing mainstream portable terminal device such as an IPHONE 4 smartphone of Apple has outline dimensions of only 115.2×58.6×9.3 cubic millimeters (mm³), the difference of 17.1 mm is quite considerable for a current portable terminal device. Therefore, if a terminal device uses the multi-band antenna provided in this embodiment, space of the terminal device may be saved such that a size of the terminal device may be reduced or space may be reserved for another device for use, thereby enhancing a function of the terminal device.

In addition, for the multi-band antenna designed based on the CRLH principle in this embodiment, when the multi-band antenna works at a fundamental frequency, surface currents on the radiation part 24 of the multi-band antenna mainly concentrate near the grounding part 25. For the antenna that is designed based on the IFA or PIFA architecture and that is shown in FIG. 1, when the antenna works at a fundamental frequency, surface current distribution on the antenna 11 at the fundamental frequency mainly concentrates on an end that is of the antenna 11 and that is close to the point B. If currents mainly concentrate near the point B on the antenna 11, when there is a ground terminal near the point B, currents on the antenna 11 are affected by the ground terminal. Consequently, a capacitance effect is generated, thereby severely affecting antenna performance. In contrast, in the multi-band antenna shown in FIG. 2, currents mainly concentrate near the grounding part 25. In this case, if there is a ground terminal near the radiation part 24 or the grounding part 25, because current distribution at a location that is of the radiation part 24 and that is away from the ground terminal is relatively small, a capacitance effect generated by the current distribution has relatively little impact on antenna performance. Current distribution is relatively large at the grounding part 25, but the grounding part 25 is electrically connected to the ground plane. Therefore, a capacitance effect generated between the ground terminal near the grounding part 25 and the radiation part 24 also has relatively little impact on antenna performance. In this way, using the terminal device configured with the multi-band antenna provided in this embodiment, design of an all-metal back cover or another all-metal appearance part may be used, and performance of the multi-band antenna is not affected greatly.

FIG. 3 is a schematic diagram of spectrums of a first resonance frequency corresponding to different capacitance values of a capacitor component. In FIG. 3, the horizontal axis indicates a frequency measured in GHz, and the vertical axis indicates a return loss measured in decibels (dB). As shown in FIG. 3, in the multi-band antenna in the embodiment shown in FIG. 2, it is assumed that the capacitor component 23 is a distributed capacitor, that is, a gap of a specific width is disposed between the feeding part 22 and the radiation part 24. A curve 31 is a corresponding spectrum curve of the first resonance frequency when a gap width is 0.1 mm, a curve 32 is a corresponding spectrum curve of the first resonance frequency when a gap width is 0.3 mm, and a curve 33 is a corresponding spectrum curve of the first resonance frequency when a gap width is 0.5 mm. A smaller gap between the feeding part 22 and the radiation part 24 indicates a larger capacitance value of the equivalent capacitor component 23. It can be seen from FIG. 3 that, when the capacitance value of the capacitor component 23 increases, the first resonance frequency moves to a low frequency.

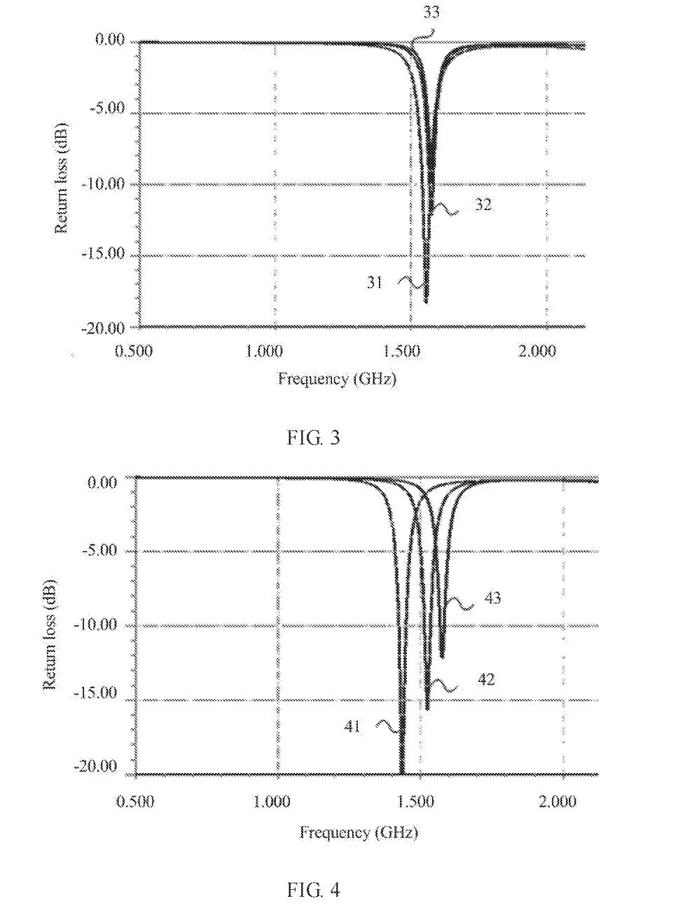

FIG. 4 is a schematic diagram of spectrums of a first resonance frequency corresponding to different widths of a grounding part. In FIG. 4, the horizontal axis indicates a frequency measured in GHz, and the vertical axis indicates a return loss measured in dB. As shown in FIG. 4, in the multi-band antenna in the embodiment shown in FIG. 2, a curve 41 is a corresponding spectrum curve of the first resonance frequency when a width W of the grounding part 25 is 0.5 mm, a curve 42 is a corresponding spectrum curve of the first resonance frequency when a width W of the grounding part 25 is 1 mm, and a curve 43 is a corresponding spectrum curve of the first resonance frequency when a width W of the grounding part 25 is 1.5 mm. A smaller width W of the grounding part 25 indicates a larger equivalent inductance value of a path from the grounding point H to the point I. It can be seen from FIG. 4 that, when the width W of the grounding part 25 increases, the first resonance frequency moves to a high frequency.

According to the multi-band antenna provided in this embodiment, disposing a capacitor component between a feeding part and a radiation part is equivalent to disposing a series resistor for the radiation part of the antenna, and a path between a grounding part and the feeding part that are of the antenna is equivalent to a parallel inductor. The feeding part, the series resistor, and the parallel inductor form a multi-band antenna that complies with a CRLH principle, which reduces an antenna size, and enables the antenna to be applied to a terminal device with an all-metal appearance part because surface current distribution of the antenna is changed.

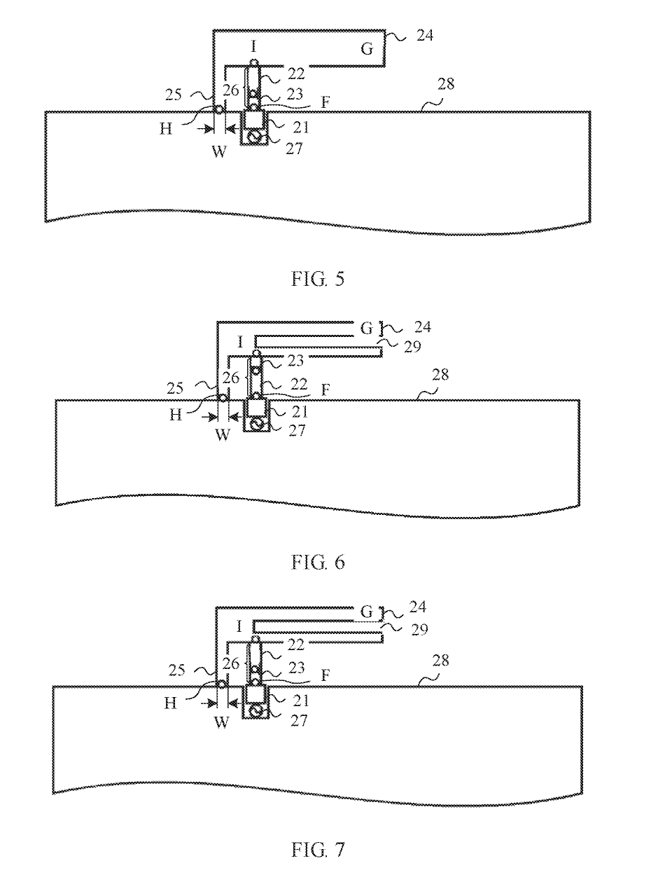

FIG. 5 is a schematic structural diagram of Embodiment 2 of a multi-band antenna according to an embodiment of the present disclosure. As shown in FIG. 5, a difference between the multi-band antenna in this embodiment and the multi-band antenna shown in FIG. 2 lies in that, in the multi-band antenna shown in FIG. 5, a capacitor component 23 is disposed between a feeding part 22 and a feeding matching circuit 21, where the feeding part 22 is electrically connected to a radiation part 24, and the capacitor component 23 is electrically connected to the feeding matching circuit 21. In the multi-band antenna shown in this embodiment, a feeding circuit 26 is still formed by the capacitor component 23 and the feeding part 22. Likewise, an antenna that complies with a CRLH principle may be formed by the capacitor component 23 and a path from a grounding part 25 to the feeding part 22.

In the embodiments shown in FIG. 2 and FIG. 5, the capacitor component 23 may be implemented using a lumped capacitor or a distributed capacitor. However, when design of a distributed capacitor is used, a gap between the feeding part 22 and the radiation part 24 needs to be controlled in order to control the capacitance value of the capacitor component 23.

FIG. 6 is a schematic structural diagram of Embodiment 3 of a multi-band antenna according to an embodiment of the present disclosure. As shown in FIG. 6, the multi-band antenna in this embodiment may be based on the multi-band antenna shown in FIG. 2, and a groove 29 is disposed on the radiation part 24, where the groove 29 extends to the grounding part 25 from the end (that is, the point G) that is of the radiation part 24 and that is away from the grounding part 25.

The groove 29 is disposed on the radiation part 24, where the groove 29 on the radiation part 24 changes electric field distribution on the radiation part 24. The electric field distribution in the groove 29 may generate a new resonance frequency on the radiation part 24, that is, the groove 29 may form a second resonant circuit on the radiation part 24. The second resonant circuit generates a third resonance frequency, and the third resonance frequency may be adjusted by adjusting a position, a length, and a width of the groove 29 on the radiation part 24. Generally, the length of the groove 29 is 0.25 times as great as a wavelength corresponding to the third resonance frequency. When the length or the width of the groove 29 increases, the third resonance frequency moves to a low frequency.

Likewise, as shown in FIG. 7, the groove 29 in the embodiment shown in FIG. 6 may alternatively be disposed based on the embodiment shown in FIG. 5. FIG. 7 is a schematic structural diagram of Embodiment 4 of a multi-band antenna according to an embodiment of the present disclosure. As shown in FIG. 7, a difference between the multi-band antenna in this embodiment and the multi-band antenna shown in FIG. 6 lies in that, in the multi-band antenna shown in FIG. 7, the capacitor component 23 is disposed between the feeding part 22 and the feeding matching circuit 21, where the feeding part 22 is electrically connected to the radiation part 24, and the capacitor component 23 is electrically connected to the feeding matching circuit 21.

The multi-band antenna that is based on the CRLH principle and that is shown in FIG. 2 or FIG. 5 may provide two resonance frequencies. After the groove shown in FIG. 6 or FIG. 7 is added, the multi-band antenna that is based on the CRLH principle and that is provided in this embodiment of the present disclosure may provide three resonance frequencies. By adjusting sizes and parameters of various parts in the multi-band antenna, the multi-band antenna may work in three different frequency bands.

FIG. 8 is a schematic structural diagram of Embodiment 5 of a multi-band antenna according to an embodiment of the present disclosure. As shown in FIG. 8, a difference between the multi-band antenna in this embodiment and the multi-band antenna shown in FIG. 6 lies in that the groove 29 in FIG. 6 is in a “-” shape, while the groove 29 in FIG. 8 is in an “L” shape. Setting the groove 29 to the “L” shape is mainly to increase the length of the groove 29 and to lower the third resonance frequency. For example, in the embodiment shown in FIG. 8, a center of the first resonance frequency is set to 1575 MHz, and a length of a path from a point G to a point F is approximately 30.5 mm. If a center of the third resonance frequency needs to be set to 2442 MHz (which is 2.4 GHz of a WI-FI frequency), the length of the groove 29 is approximately 30.7 mm. It can be learned that, if the groove 29 is set to the “-” shape, the length of the radiation part 24 may be insufficient. Therefore, the groove 29 may be set to the “L” shape such that the center of the third resonance frequency may be set to 2442 MHz.

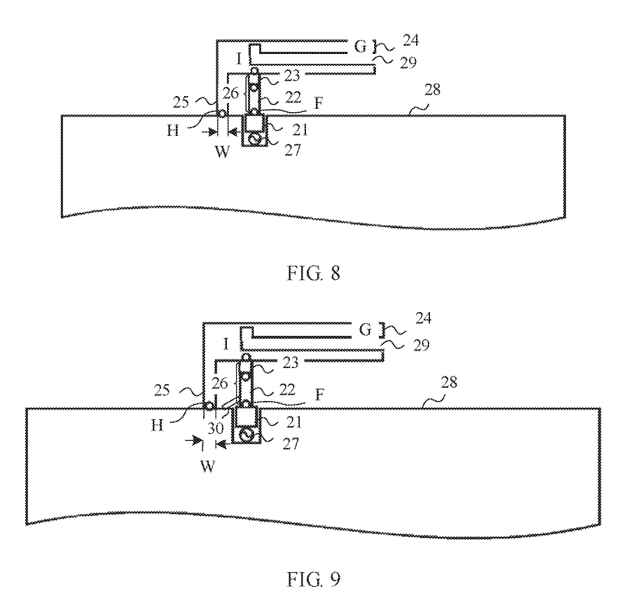

FIG. 9 is a schematic structural diagram of Embodiment 6 of a multi-band antenna according to an embodiment of the present disclosure. As shown in FIG. 9, on the basis of the multi-band antenna shown in FIG. 8, the multi-band antenna in this embodiment further includes a matching capacitor 30. The matching capacitor 30 is disposed between the feeding matching circuit 21 and the ground plane 28. The matching capacitor 30 is configured to match a second resonance frequency. When the second resonance frequency is in a 5 GHz frequency band (5150 MHz to 5850 MHz, such as a frequency band of WI-FI), the matching capacitor 30 may be set to 0.4 pF. Likewise, the matching capacitor 30 shown in this embodiment may alternatively be disposed on multi-band antennas provided in other embodiments of the present disclosure.

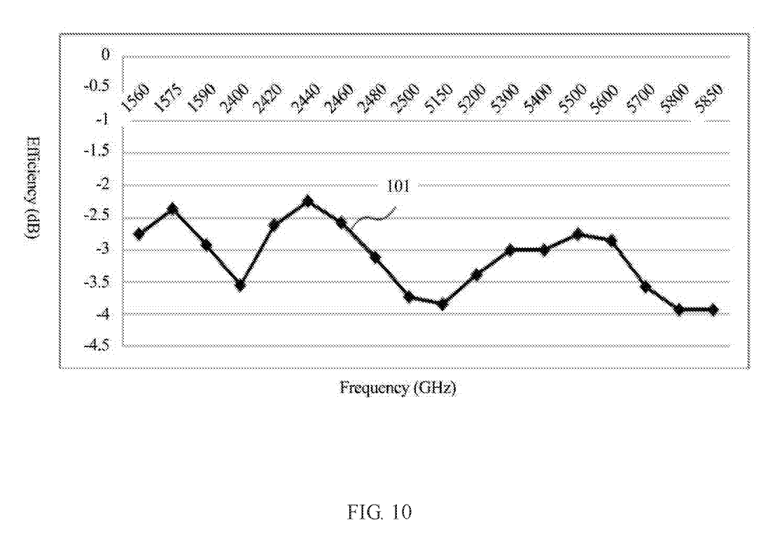

FIG. 10 is a diagram of antenna radiation efficiency of the multi-band antenna in the embodiment shown in FIG. 9. In the figure, the horizontal axis indicates a frequency measured in GHz, and the vertical axis indicates efficiency measured in dB. In the multi-band antenna in the embodiment shown in FIG. 10, a center of the first resonance frequency is set to 1575 MHz (a GPS frequency), a center of the second resonance frequency is set to 5500 MHz (5 GHz of a WI-FI frequency), and a center of the third resonance frequency is set to 2442 MHz (2.4 GHz of a WI-FI frequency). In FIG. 10, a curve 101 is an efficiency curve of the multi-band antenna in the embodiment shown in FIG. 9. It can be seen from the curve 101 that, efficiency of the multi-band antenna in the embodiment shown in FIG. 9 in the GPS frequency approximately ranges from −2.36 dB to −2.92 dB, efficiency in 5 GHz of the WI-FI frequency approximately ranges from −2.24 dB to −3.73 dB, and efficiency in 2.4 GHz of the WI-FI frequency approximately ranges from −2.74 dB to −3.93 dB. It can be learned that, the multi-band antenna in the embodiment shown in FIG. 9 meets an actual working requirement.

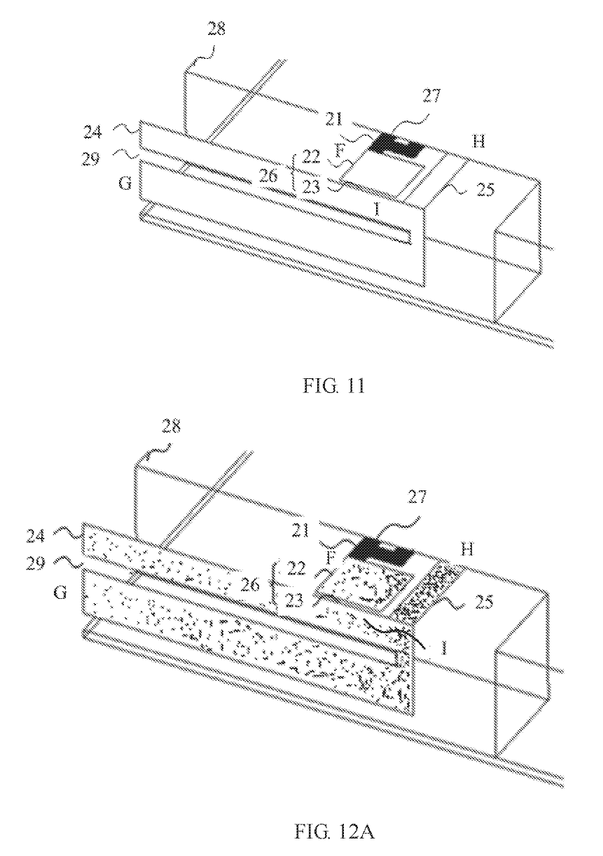

FIG. 11 is a schematic structural diagram of Embodiment 7 of a multi-band antenna according to an embodiment of the present disclosure. As shown in FIG. 11, a difference between the multi-band antenna in this embodiment and the multi-band antenna shown in FIG. 7 lies in that various parts in the multi-band antenna shown in FIG. 7 may be all located on a same plane, for example, the plane may be the ground plane 28 on which the multi-band antenna is disposed. For example, the multi-band antenna may be a microstrip structure. In contrast, in the multi-band antenna shown in FIG. 11, the feeding matching circuit 21, the feeding part 22, the capacitor component 23, and the grounding part 25 are located on a same plane, and the radiation part 24 may be disposed on a plane that is perpendicular to the plane. For example, the plane may be the ground plane 28 on which the multi-band antenna is disposed, and the radiation part 24 may be disposed on a plane that is perpendicular to the ground plane 28.

Generally, in a terminal device configured with a multi-band antenna, to ensure a radiation effect of the multi-band antenna, the multi-band antenna is disposed on an edge of the terminal device. Therefore, in the multi-band antenna in the embodiment shown in FIG. 11, the radiation part 24 may be disposed on a side of the terminal device, to ensure the radiation effect of the multi-band antenna. Compared with the multi-band antenna shown in FIG. 7, the multi-band antenna shown in the FIG. 11 can further save space of the terminal device.

In the multi-band antenna shown in FIG. 11, there is a gap between the feeding part 22 and the radiation part 24, where the gap presents a capacitor characteristic, and the gap may be the capacitor component 23.

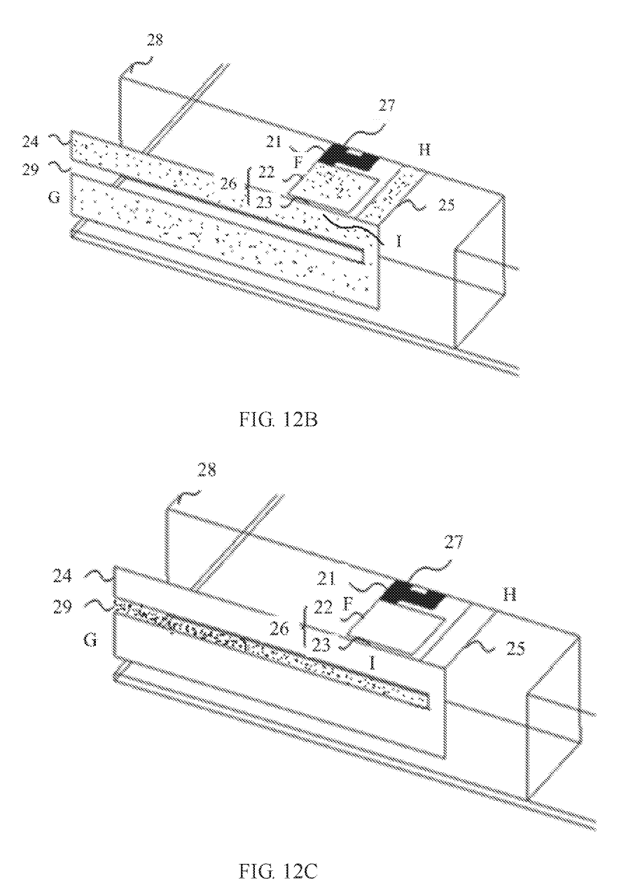

FIG. 12A to FIG. 12C are schematic diagrams of surface current distribution and electric field distribution of the multi-band antenna shown in FIG. 11. It is assumed that in the multi-band antenna shown in FIG. 11, the first resonance frequency is 1575 MHz, the second resonance frequency is 5500 MHz, and the third resonance frequency is 2442 MHz. In FIG. 12A, a density degree of surface filling of the radiation part 24 is used to indicate a status of surface current distribution of the radiation part 24, where denser filling indicates a stronger current, and sparser filling indicates a weaker current. As shown in FIG. 12A, when the multi-band antenna works in the first resonance frequency 1575 MHz, the surface current distribution of the multi-band antenna mainly concentrates near a point H connected between the grounding part 25 and the ground plane 28, while the lowest surface current is distributed near a point G that is of the radiation part 24 and that is away from the grounding part. In FIG. 12A, after the surface current density of the radiation part 24 is quantized, a current density near the point H is approximately 500 ampere per meter (A/m), while a current density near the point G is only approximately 10 A/m. In FIG. 12B, a density degree of surface filling of the radiation part 24 is used to indicate a status of surface current distribution of the radiation part 24, where denser filling indicates a stronger current, and sparser filling indicates a weaker current. As shown in FIG. 12B, when the multi-band antenna works in the second resonance frequency 5500 MHz, the surface current distribution of the multi-band antenna mainly concentrates near the point H connected between the grounding part 25 and the ground plane 28, while the lowest surface current is distributed near the point G that is of the radiation part 24 and that is away from the grounding part. In FIG. 12B, after the surface current density of the radiation part 24 is quantized, a current density near the point G is approximately 10 A/m, while a current density near the point H is approximately 70-100 A/m. In FIG. 12C, a density degree of filling inside the groove 29 is used to indicate a change status of electric field strength inside the groove 29, where denser filling indicates stronger electric field strength, and sparser filling indicates weaker electric field strength. As shown in FIG. 12C, when the multi-band antenna works in the third resonance frequency 2442 MHz, an electric field in the groove 29 is relatively strong on a side of the point G that is close to the radiation part 24 and that is away from the grounding part, while an electric field is relatively weak near a point I connected between the feeding circuit 26 and the radiation part 24. After the electric field strength of the groove 29 in FIG. 12C is quantized, an electric field on a side near the point G is approximately 10000 volt per meter (V/m), and an electric field on a side near the point I is approximately 2000 V/m.

It can be learned based on FIG. 12A to FIG. 12C that, when the multi-band antenna works in the first resonance frequency and the second resonance frequency, the current of the multi-band antenna concentrates on the surface of the radiation part 24 and near the point H, while the current near the point G is relatively weak. Therefore, if a metal back cover is installed near the multi-band antenna, the surface current on the radiation part 24 and a capacitance effect generated by the metal back cover are relatively small. In this case, working of the multi-band antenna is not affected. However, when the multi-band antenna works in the third resonance frequency, the electric field concentrates on the groove 29 rather than on the surface of the radiation part 24. Therefore, the metal back cover near the multi-band antenna does not affect the multi-band antenna greatly.

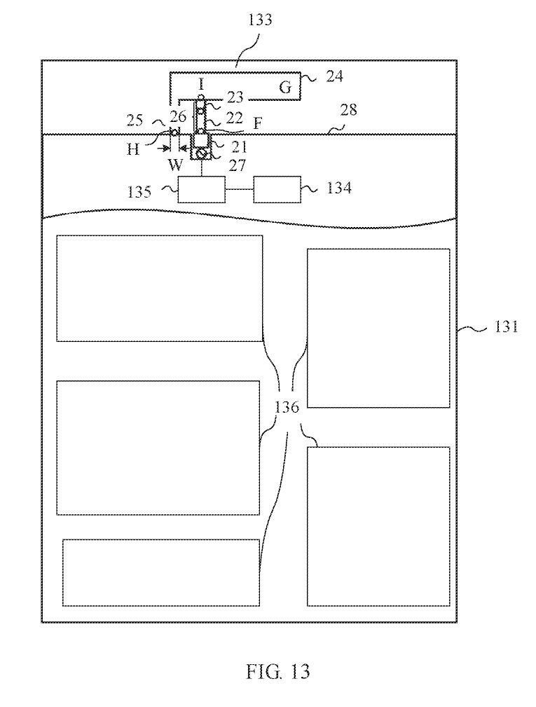

FIG. 13 is a schematic structural diagram of Embodiment 1 of a terminal device according to an embodiment of the present disclosure. As shown in FIG. 13, the terminal device provided in this embodiment includes a housing 131, a feeding radio frequency circuit 27, a multi-band antenna 133, a frequency mixing circuit 135, and a baseband processing circuit 134, where the feeding radio frequency circuit 27, the multi-band antenna 133, the frequency mixing circuit 135, and the baseband processing circuit 134 are located inside the housing 131. The housing 131 may further include another device 136.

The feeding radio frequency circuit 27 is configured to process a radio frequency signal received using the multi-band antenna 133 and send a processed signal to the frequency mixing circuit 135 for down-conversion processing. The frequency mixing circuit 135 sends an intermediate frequency signal obtained by means of down-conversion to the baseband processing circuit 134 for processing, or the baseband processing circuit 134 sends a baseband signal to the frequency mixing circuit 135 for up-conversion to obtain a radio frequency signal, and then the frequency mixing circuit 135 sends the radio frequency signal to the feeding radio frequency circuit 27 and the radio frequency signal is transmitted using the multi-band antenna 133.

The terminal device shown in this embodiment may be any type of portable terminal device that needs to perform wireless communication, such as a mobile phone and a tablet computer. The multi-band antenna 133 may be any type of multi-band antenna in the embodiments shown in FIG. 2, FIG. 5, FIG. 6, FIG. 7, FIG. 8, FIG. 9, or FIG. 11. For a specific structure and an implementation principle of the multi-band antenna 133, reference may be made to the multi-band antenna in the embodiments shown in FIG. 2, FIG. 5, FIG. 6, FIG. 7, FIG. 8, FIG. 9, or FIG. 11, and details are not described herein again.

In the terminal device provided in this embodiment, overall dimensions of the terminal device are 140×70×7 mm³, but the multi-band antenna 133 occupies only 20×6×7 mm³.

In the terminal device shown in this embodiment, the multi-band antenna shown in FIG. 2, FIG. 5, FIG. 6, FIG. 7, FIG. 8, FIG. 9, or FIG. 11 is used, and a size of the multi-band antenna is relatively small. Therefore, a size of an entire terminal device may be further reduced, which meets a miniaturized design trend of a current terminal device. On the premise of not changing outline dimensions of the terminal device, the saved space may be used for installing more functional devices for the terminal device. In addition, because the multi-band antenna complies with the CRLH principle, the housing 131 of the multi-band antenna may be produced using an all-metal appearance part, without affecting performance of the multi-band antenna. Generally, the housing 131 of the terminal device may be made of a metal material, which can improve an appearance of the terminal device and enhance holding feeling of the terminal device, thereby attracting consumers to make a purchase.

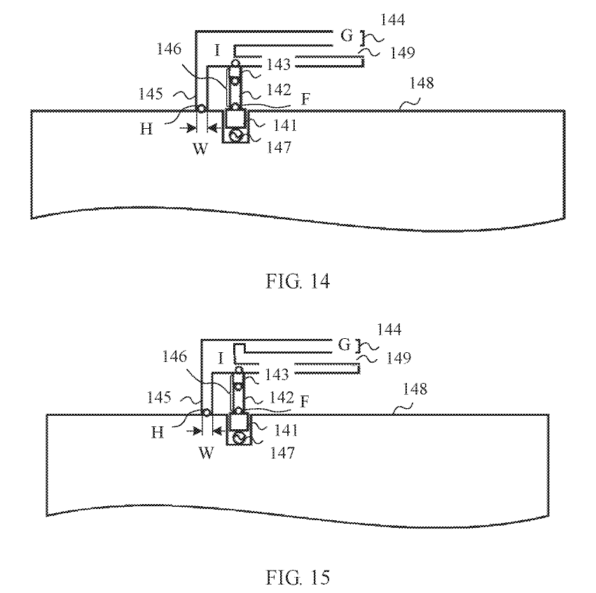

FIG. 14 is a schematic structural diagram of Embodiment 8 of a multi-band antenna according to an embodiment. As shown in FIG. 14, the multi-band antenna in this embodiment includes a feeding matching circuit 141, a feeding part 142, a capacitor component 143, a radiation part 144, and a grounding part 145.

The feeding part 142 is connected to the capacitor component 143 to form a feeding circuit 146. The feeding matching circuit 141 is electrically connected between a feeding radio frequency circuit 147 and the feeding part 142, and the capacitor component 143 is connected to the radiation part 144. The feeding matching circuit 141 is configured to match a radio frequency signal in the feeding radio frequency circuit 147 and the feeding circuit 146. The feeding part 142 is configured to feed a radio frequency signal generated by the feeding radio frequency circuit 147 into the radiation part 144, or feed a radio frequency signal generated by the radiation part 144 into the feeding radio frequency circuit 147. The radiation part 144 is electrically connected both to the capacitor component 143 and the grounding part 145, the grounding part 145 is electrically connected to a ground plane 148, a first resonant circuit (that is, a path from a point F to a point G in FIG. 14) is formed from the feeding circuit 146 to an end that is of the radiation part 144 and that is away from the grounding part 145, and the first resonant circuit generates a first resonance frequency and a second resonance frequency. Generally, the grounding part 145 and the radiation part 144 are an integrated metal plate, that is, a part of the radiation part 144 extending to the ground plane 148 is the grounding part 145. A width of the grounding part 145 may be W.

The feeding part 142, the radiation part 144, and the grounding part 145 form a basic antenna structure. In addition, impedance does not match between the feeding radio frequency circuit 147 and the feeding part 142. Therefore, the feeding matching circuit 141 is electrically connected between the feeding radio frequency circuit 147 and the feeding part 142. The feeding matching circuit 141 is configured to match a radio frequency signal in the feeding radio frequency circuit 147 and the feeding part 142, including matching a signal transmitted by the feeding radio frequency circuit 147 and transmitting the matched signal to the feeding circuit 146, and then radiating the matched signal using the radiation part 144, or matching a signal that is transmitted by the feeding circuit 146 and that is received by the radiation part 144, and then transmitting the matched signal to the feeding radio frequency circuit 147. The capacitor component 143 is further disposed between the feeding part 142 and the radiation part 144, where the capacitor component 143 and the feeding part 142 form the feeding circuit 146. The capacitor component 143 may be a lumped capacitor, or may be a distributed capacitor. If the capacitor component 143 is a lumped capacitor, the lumped capacitor device whose capacitance value is determined is connected (for example, in a welding manner) between the feeding part 142 and the radiation part 144. If the capacitor component 143 is a distributed capacitor, a specific gap may be reserved between the feeding part 142 and the radiation part 144. The gap presents a characteristic of the distributed capacitor, and the capacitance value of the distributed capacitor may be adjusted by adjusting a width of the gap between the feeding part 142 and the radiation part 144. For example, when the width of the gap between the feeding part 142 and the radiation part 144 is 0.3 mm, the capacitance value of the distributed capacitor may be equivalent to a 0.4 pF capacitance value of the lumped capacitor.

Optionally, a groove 149 is disposed on the radiation part 144, where the groove 149 extends to the grounding part 145 from the end (that is, the point G) that is of the radiation part 144 and that is away from the grounding part 145.

A part from a connection point H between the grounding part 145 and the ground plane 148 to a connection point I between the feeding circuit 146 and the radiation part 144 forms an inductor that is in parallel with the radiation part 144. The capacitor component 143 and the radiation part 144 are in a serial connection relationship, which is equivalent to a series resistor. According to the principle of the CRLH antenna, the parallel inductor and the series resistor form a core component that complies with a principle of a right/left handed transmission line, and the path from the point G that is of the radiation part 144 of the multi-band antenna and that is away from the grounding part 145 to the point F connected between the feeding part 142 and the feeding radio frequency circuit 147 forms the first resonant circuit. The first resonant circuit generates the first resonance frequency, where the first resonance frequency is a fundamental frequency of the multi-band antenna. In addition, according to the CRLH principle, the first resonant circuit further generates the second resonance frequency, where the second resonance frequency is a multiplied frequency of the first resonance frequency. The first resonance frequency complies with a left handed rule, and the second resonance frequency complies with a right handed rule. The groove 149 is disposed on the radiation part 144, where the groove 149 on the radiation part 144 changes electric field distribution on the radiation part 144. The electric field distribution in the groove 149 may generate a new resonance frequency on the radiation part 144, that is, the groove 149 may form a second resonant circuit on the radiation part 144, and the second resonant circuit generates a third resonance frequency.

Therefore, the multi-band antenna shown in FIG. 14 generates three resonance frequencies, and the first resonance frequency, the second frequency, and the third resonance frequency may be adjusted by adjusting sizes and parameters of various parts in the multi-band antenna. By adjusting a length of the path from the point G to the point F, a length of the first resonant circuit may be adjusted, that is, a magnitude of the first resonance frequency is adjusted, and a magnitude of the second resonance frequency also changes. By adjusting a capacitance value of the capacitor component 143, a resonance frequency may be adjusted for the first resonant circuit, where the capacitance value of the capacitor component 143 is inversely proportional to the first resonance frequency. By adjusting a width W of the grounding part 145, the second resonance frequency may also be adjusted, where the width W of the grounding part 145 is inversely proportional to the second resonance frequency. Increasing the width W of the grounding part 145 is equivalent to increasing an equivalent inductance value of the inductor that is in parallel with the first resonant circuit. By adjusting a position, a length, and a width of the groove 149 on the radiation part 144, the third resonance frequency may be adjusted. Generally, the length of the groove 149 is 0.25 times as great as a wavelength corresponding to the third resonance frequency. When the length or the width of the groove 149 increases, the third resonance frequency moves to a low frequency.

The multi-band antenna provided in this embodiment is disposed in a terminal device that needs to work in multiple wireless frequency bands. The feeding radio frequency circuit 147 is disposed in the terminal device, where the feeding radio frequency circuit 147 is configured to process a radio frequency signal received using the multi-band antenna or transmit a generated radio frequency signal using the multi-band antenna. The ground plane 148 for grounding is further disposed in the terminal device. The ground plane 148 is generally a copper cover on a circuit board in the terminal device, for example, a copper layer of the circuit board.

It can be learned from the principle of the CRLH antenna that, for the antenna based on the CRLH principle, a length of a resonant circuit that generates a fundamental frequency approximately ranges from 0.12 times to 0.18 times as great as a wavelength corresponding to the fundamental frequency. In contrast, for the antenna (for example, the antenna 11 shown in FIG. 1) designed based on the IFA or PIFA principle, a length of a resonant circuit that generates a fundamental frequency is approximately 0.25 times as great as a wavelength corresponding to the fundamental frequency. Therefore, the wavelength corresponding to the fundamental frequency for the multi-band antenna provided in this embodiment is 0.09 times shorter than that for the antenna based on the IFA or PIFA principle, which is quite important to a terminal device of increasingly miniaturized design. For example, the fundamental frequency of the multi-band antenna in this embodiment is designed at a GPS frequency, and in an L1 frequency band of GPS, a center frequency of the fundamental frequency of the multi-band antenna is 1575 MHz, and a wavelength corresponding to 1575 MHz is approximately 190 mm. If the antenna designed based on the IFA or PIFA principle is used, a length of the antenna is approximately 47.6 mm. If the antenna provided in this embodiment is used, a length of the antenna approximately ranges from 30.5 mm to 34.3 mm. A length difference between the two antennas reaches 17.1 mm. Considering that an existing mainstream portable terminal device such as an IPHONE 4 smartphone of APPLE Incorporation has outline dimensions of only 115.2×58.6×9.3 mm³, it can be learned that, the difference of 17.1 mm is quite considerable for a current portable terminal device. Therefore, if a terminal device uses the multi-band antenna provided in this embodiment, space of the terminal device may be saved such that a size of the terminal device may be reduced or space may be reserved for another device for use, thereby enhancing a function of the terminal device.

In addition, for the multi-band antenna designed based on the CRLH principle in this embodiment, when the multi-band antenna works at a fundamental frequency, surface currents on the radiation part 144 of the multi-band antenna mainly concentrate near the grounding part 145. For the antenna 11 that is designed based on the IFA or PIFA architecture and that is shown in FIG. 1, when the antenna 11 works at a fundamental frequency, surface current distribution on the antenna 11 at the fundamental frequency mainly concentrates on an end that is of the antenna 11 and that is close to a point B. If currents mainly concentrate near the point B on the antenna 11, when there is a ground terminal near the point B, currents on the antenna 11 are affected by the ground terminal, consequently, a capacitance effect is generated, thereby severely affecting antenna performance. In contrast, in the multi-band antenna shown in FIG. 14, currents mainly concentrate near the grounding part 145. In this case, if there is a ground terminal near the radiation part 144 or the grounding part 145, because current distribution at a location that is of the radiation part 144 and that is away from the ground terminal is relatively small, a capacitance effect generated by the current distribution has relatively little impact on antenna performance. Current distribution is relatively large at the grounding part 145, but the grounding part 145 is electrically connected to the ground plane. Therefore, a capacitance effect generated between the ground terminal near the grounding part 145 and the radiation part 144 also has relatively little impact on antenna performance. In this way, using the terminal device configured with the multi-band antenna provided in this embodiment, design of a metal back cover or another metal appearance part is used, and performance of the multi-band antenna is not affected greatly.

FIG. 15 is a schematic structural diagram of Embodiment 9 of a multi-band antenna according to an embodiment of the present disclosure. As shown in FIG. 15, a difference between the multi-band antenna in this embodiment and the multi-band antenna shown in FIG. 14 lies in that the groove 149 in FIG. 14 is in a “-” shape, while the groove 149 in FIG. 15 is in an “L” shape. Setting the groove 149 to the “L” shape is mainly to increase the length of the groove 149 and to lower the third resonance frequency. For example, in the embodiment shown in FIG. 15, a center of the first resonance frequency is set to 1575 MHz, and a length of a path from a point G to a point F is approximately 30.5 mm. If a center of the third resonance frequency needs to be set to 2442 MHz (which is 2.4 GHz of a WI-FI frequency), the length of the groove 149 is approximately 30.7 mm. It can be learned that, if the groove 149 is set to the “-” shape, the length of the radiation part 144 may be insufficient. Therefore, the groove 149 may be set to the “L” shape such that the center of the third resonance frequency may be set to 2442 MHz.

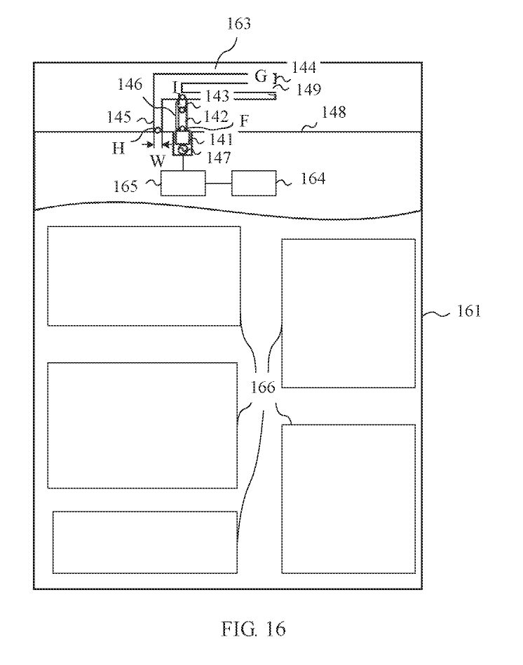

FIG. 16 is a schematic structural diagram of Embodiment 2 of a terminal device according to an embodiment of the present disclosure. As shown in FIG. 16, the terminal device provided in this embodiment includes a housing 161, a feeding radio frequency circuit 147, a multi-band antenna 163, a baseband processing circuit 164, and a frequency mixing circuit 165, where the feeding radio frequency circuit 147, the multi-band antenna 163, the baseband processing circuit 164, and the frequency mixing circuit 165 are located inside the housing 161. The housing 161 may further include another device 166.

The feeding radio frequency circuit 147 is configured to process a radio frequency signal received using the multi-band antenna 163 and send a processed signal to the frequency mixing circuit 165 for down-conversion processing. The frequency mixing circuit 165 sends an intermediate frequency signal obtained by means of down-conversion to the baseband processing circuit 164 for baseband processing, or the baseband processing circuit 164 sends a baseband signal to the frequency mixing circuit 165 for up-conversion to obtain a radio frequency signal, and then the frequency mixing circuit 165 sends the radio frequency signal to the feeding radio frequency circuit 147 and the radio frequency signal is transmitted using the multi-band antenna 163.

The terminal device shown in this embodiment may be any type of portable terminal device that needs to perform wireless communication, such as a mobile phone and a tablet computer. The multi-band antenna 163 may be any type of multi-band antenna in embodiments shown in FIG. 14 or FIG. 15. For a specific structure and an implementation principle of the multi-band antenna 163, reference may be made to the multi-band antenna in the embodiments shown in FIG. 14 or FIG. 15, and details are not described herein again.

In the terminal device provided in this embodiment, overall dimensions of the terminal device are 140×70×7 mm³, but the multi-band antenna 133 occupies only 20×6×7 mm³.

In the terminal device shown in this embodiment, the multi-band antenna shown in FIG. 14 or FIG. 15 is used, and a size of the multi-band antenna is relatively small. Therefore, a size of an entire terminal device may be further reduced, which meets a miniaturized design trend of a current terminal device. On the premise of not changing outline dimensions of the terminal device, the saved space may be used for installing more functional devices for the terminal device. In addition, because the multi-band antenna complies with the CRLH principle, the housing 161 of the multi-band antenna may be produced using a metal appearance part, without affecting performance of the multi-band antenna. Generally, a back cover of the housing 161 of the terminal device may be made of a metal material, which can improve an appearance of the terminal device and enhance holding feeling of the terminal device, thereby attracting consumers to make a purchase.

Finally, it should be noted that the foregoing embodiments are merely intended to describe the technical solutions of the present disclosure, but not to limit the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof. Therefore, the protection scope of the present disclosure shall be subject to the protection scope of the claims.

1.-5. (canceled)

6. A terminal device, comprising:
a housing;
a baseband processing circuit;
a frequency mixing circuit;
a feeding radio frequency circuit; and
a multi-band antenna,
wherein the baseband processing circuit, the frequency mixing circuit, the feeding radio frequency circuit, and the multi-band antenna are located inside the housing,
wherein the baseband processing circuit is connected to the frequency mixing circuit,
wherein the frequency mixing circuit is connected to the feeding radio frequency circuit, and
wherein the multi-band antenna comprises:
a feeding matching circuit;
a feeding part;
a capacitor component;
a radiation part; and
a grounding part,
wherein the feeding part is connected to the capacitor component to form a feeding circuit,
wherein the feeding matching circuit is electrically connected between the feeding radio frequency circuit and the feeding circuit,
wherein the radiation part is electrically connected both to the feeding circuit and the grounding part,
wherein the grounding part is electrically connected to a ground plane,
wherein a first resonant circuit is formed from the feeding circuit to an end of the radiation part that is away from the grounding part,
wherein the first resonant circuit is configured to generate a first resonance frequency and a second resonance frequency,
wherein the first resonance frequency is a global positioning system (GPS) frequency,
wherein the second resonance frequency is a multiplied frequency of the first resonance frequency,
wherein a length of the first resonant circuit ranges from 0.12 times to 0.18 times as great as a wavelength corresponding to the first resonance frequency, and
wherein a width of the grounding part ranges from 0.5 millimeter to 2.5 millimeters.

7. The terminal device according to claim 6, wherein a groove is disposed on the radiation part, wherein the groove extends to the grounding part from the end of the radiation part that is away from the grounding part, wherein the groove is configured to form a second resonant circuit on the radiation part, wherein the second resonant circuit generates a third resonance frequency, and wherein the third resonance frequency is different from the first resonance frequency and the second resonance frequency.

8. The terminal device according to claim 6, wherein a capacitance value of the capacitor component is inversely proportional to the first resonance frequency.

9. The terminal device according to claim 6, wherein the width of the grounding part is inversely proportional to the second resonance frequency.

10. The terminal device according to claim 6, wherein the ground plane is a copper layer of a circuit board in the terminal device.

11. A multi-band antenna, comprising:
a feeding matching circuit;
a feeding part;
a capacitor component;
a radiation part; and
a grounding part,
wherein the feeding part is connected to the capacitor component to form a feeding circuit,
wherein the feeding matching circuit is electrically connected between a feeding radio frequency circuit and the feeding circuit,
wherein the radiation part is electrically connected both to the feeding circuit and the grounding part,
wherein the grounding part is electrically connected to a ground plane,
wherein a first resonant circuit is formed from the feeding circuit to an end of the radiation part that is away from the grounding part,
wherein the first resonant circuit venerates a first resonance frequency and a second resonance frequency, and
wherein the second resonance frequency is a multiplied frequency of the first resonance frequency.

12. The multi-band antenna according to claim 11, wherein a groove is disposed on the radiation part, wherein the groove extends to the grounding part from the end of the radiation part that is away from the grounding part, wherein the groove is configured to form a second resonant circuit on the radiation part, wherein the second resonant circuit generates a third resonance frequency, and wherein the third resonance frequency is different from the first resonance frequency and the second resonance frequency.

13. The multi-band antenna according to claim 12, wherein a length of the groove is inversely proportional to the third resonance frequency.

14. The multi-band antenna according to claim 11, wherein a width of the grounding part is inversely proportional to the second resonance frequency.

15. The multi-band antenna according to claim 11, wherein the ground plane is a copper layer of a circuit board.

16. A terminal device, comprising:
a housing;
a baseband processing circuit;
a frequency mixing circuit;
a feeding radio frequency circuit; and
a multi-band antenna,
wherein the baseband processing circuit, the frequency mixing circuit, the feeding radio frequency circuit, and the multi-band antenna are located inside the housing,
wherein the baseband processing circuit and the frequency mixing circuit are connected to the feeding radio frequency circuit, and
wherein the multi-band antenna comprises:
a feeding matching circuit;
a feeding part;
a capacitor component;
a radiation part; and
a grounding part,
wherein the feeding part is connected to the capacitor component to form a feeding circuit,
wherein the feeding matching circuit is electrically connected between the feeding radio frequency circuit and the feeding circuit,
wherein the radiation part is electrically connected both to the feeding circuit and the grounding part,
wherein the grounding part is electrically connected to a ground plane,
wherein a first resonant circuit is formed from the feeding circuit to an end of the radiation part that is away from the grounding part,
wherein the first resonant circuit generates a first resonance frequency and a second resonance frequency, and
wherein the second resonance frequency is a multiplied frequency of the first resonance frequency.

17. The terminal device according to claim 16, wherein a groove is disposed on the radiation part, wherein the groove extends to the grounding part from the end that is of the radiation part that is away from the grounding part, wherein the groove is configured to form a second resonant circuit on the radiation part, wherein the second resonant circuit generates a third resonance frequency, and wherein the third resonance frequency is different from the first resonance frequency and the second resonance frequency.

18. The terminal device according to claim 17, wherein a length of the groove is inversely proportional to the third resonance frequency.

19. The terminal device according to claim 16, wherein a width of the grounding part is inversely proportional to the second resonance frequency.

20. The terminal device according to claim 16, wherein the ground plane is a copper layer of a circuit board in the terminal device.

21. The multi-band antenna according to claim 11, wherein the first resonance frequency is a global positioning system (GPS) frequency, wherein a length of the first resonant circuit ranges from 0.12 times to 0.18 times as great as a wavelength corresponding to the first resonance frequency, and wherein a width of the grounding part ranges from 0.5 millimeter to 2.5 millimeters.

22. The multi-band antenna according to claim 11, wherein a capacitance value of the capacitor component is inversely proportional to the first resonance frequency.
